(19) United States
(12) Patent Application Publication
(10) Pub. No.: US 2018/0354734 A1
(43) Pub. Date: Dec. 13, 2018

(54) SHEET FEEDING APPARATUS

(71) Applicant: KONICA MINOLTA, INC., Tokyo (JP)

(72) Inventors: Ryo Oshima, Tokyo (JP); Hiroaki Takada, Tokyo (JP); Daisuke Kawate, Tokyo (JP); Shougo Kamiya, Otsuki-shi (JP); Yoshiaki Kondoh, Tokyo (JP)

(73) Assignee: KONICA MINOLTA, INC., Tokyo (JP)

(21) Appl. No.: 15/974,863

(22) Filed: May 9, 2018

(30) Foreign Application Priority Data
Jun. 8, 2017 (JP) 2017-113715

(51) Int. Cl. B65H 5/06; B41J 13/10; B65H 3/06

(52) U.S. Cl. CPC B65H 5/062; B65H 2801/06; B65H 3/0669; B41J 13/103

(57) ABSTRACT

A sheet feeding apparatus includes: a stacking part capable of stacking a plurality of sheet packs including a bundle of stacked printing sheets being wrapped with a wrapping sheet; a side surface remover that removes the wrapping sheet on a side surface being a wall surface along a stacking direction of the printing sheets among the wall surfaces of the sheet pack for each of the plurality of sheet packs stacked on the stacking part, a sensor that detects whether an uppermost sheet stacked on the stacking part in a detection range is the wrapping sheet; and a conveyer that conveys the detected wrapping sheet to a path different from a path through which the printing sheet is conveyed in a case where the wrapping sheet has been detected by the sensor.

The entire disclosure of Japanese patent Application No. 2017-113715, filed on Jun. 8, 2017, is incorporated herein by reference in its entirety.

### BACKGROUND

### Technological Field

The present invention relates to a sheet feeding apparatus.

### Description of the Related Art

An image forming apparatus such as a printer includes a sheet feeding apparatus that accommodates a bundle of stacked printing sheets (hereinafter referred to as “a bundle of sheets”) and feeds the printing sheets. Conventionally, various techniques have been proposed in order to reduce the burden of a user in opening a wrapping sheet of a sheet pack to extract the bundle of sheets and refilling the sheet feeding apparatus.

For example, JP 2003-95456 A proposes a sheet feeding apparatus that opens a package by pulling a perforated wrapping sheet inside the apparatus to make it possible to feed the printing sheet. Another publication JP 2016-159998 A discloses a sheet feeding apparatus that opens a non-processed wrapping sheet inside the apparatus by using a plurality of blades or the like to make it possible to feed the printing sheet.

Unfortunately, however, the sheet feeding apparatus described in JP 2003-95456 A and JP 2016-159998 A can merely open the sheet pack one at a time. Therefore, in a case where the sheet feeding apparatus is a large capacity sheet feeding apparatus capable of internally stacking a plurality of sheet packs, the wrapping sheet of a subsequent sheet pack is to be opened after all the sheets in the opened sheet pack are fed. Accordingly, there is a case where the sheet feeding apparatus needs to open the sheet pack during execution of printing, leading to a problem of low productivity.

### SUMMARY

The present invention has been made in view of the above circumstances, and an object thereof is to provide a sheet feeding apparatus achieving higher efficiency in sheet pack wrapping sheet removal processing.

To achieve the abovementioned object, according to an aspect of the present invention, a sheet feeding apparatus reflecting one aspect of the present invention comprises: a stacking part capable of stacking a plurality of sheet packs including a bundle of stacked printing sheets being wrapped with a wrapping sheet; a side surface remover that removes the wrapping sheet on a side surface being a wall surface along a stacking direction of the printing sheets among the wall surfaces of the sheet pack for each of the plurality of sheet packs stacked on the stacking part, a sensor that detects whether an uppermost sheet stacked on the stacking part in a detection range is the wrapping sheet; and a conveyer that conveys the detected wrapping sheet to a path different from a path through which the printing sheet is conveyed in a case where the wrapping sheet has been detected by the sensor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming apparatus and a sheet feeding apparatus according to an embodiment of the present invention;

FIG. 2 is a block diagram illustrating a schematic configuration of the image forming apparatus and the sheet feeding apparatus;

FIG. 3 is a perspective view illustrating a schematic configuration of the sheet feeding apparatus;

FIG. 4A is a diagram illustrating a pipe member provided in a side surface remover;

FIG. 4B is a diagram illustrating a state in which the pipe member sucks air;

FIG. 4C is a diagram illustrating a state in which the pipe member removes the side surface wrapping sheet of the sheet pack;

FIG. 4D is a diagram illustrating a state in which the pipe member removes the side surface wrapping sheet of the sheet pack;

FIG. 5A is a diagram for illustrating a method of removing the side surface wrapping sheet of a sheet pack;

FIG. 5B is a diagram for illustrating a method of removing the side surface wrapping sheet of a sheet pack;

FIG. 5C is a diagram for illustrating a method of removing the side surface wrapping sheet of a sheet pack;

FIG. 5D is a diagram for illustrating a method of removing the side surface wrapping sheet of a sheet pack;

FIG. 6A is a diagram for illustrating a method of removing a wrapping sheet on the upper and lower surfaces of a sheet pack;

FIG. 6B is a diagram for illustrating a method of removing a wrapping sheet on the upper and lower surfaces of a sheet pack;

FIG. 6C is a diagram for illustrating a method of removing a wrapping sheet on the upper and lower surfaces of a sheet pack;

FIG. 6D is a diagram for illustrating a method of removing a wrapping sheet on the upper and lower surfaces of a sheet pack;

FIG. 6E is a diagram for illustrating a method of removing a wrapping sheet on the upper and lower surfaces of a sheet pack;

FIG. 6F is a diagram for illustrating a method of removing a wrapping sheet on the upper and lower surfaces of a sheet pack;

FIG. 6G is a diagram for illustrating a method of removing a wrapping sheet on the upper and lower surfaces of a sheet pack;

FIG. 6H is a diagram for illustrating a method of removing a wrapping sheet on the upper and lower surfaces of a sheet pack;

FIG. 7 is a flowchart illustrating a procedure of processing executed in the sheet feeding apparatus; and

FIG. 8 is a diagram for illustrating a first sensor and a second sensor of a modification.

### DETAILED DESCRIPTION OF EMBODIMENTS

Hereinafter, one or more embodiments of the present invention will be described with reference to the drawings. However, the scope of the invention is not limited to the disclosed embodiments. In describing the drawings, a same reference sign will be given to same components and overlapping description will be omitted. Note that, for the purpose of explanation, proportions of dimensions in the drawings may be expanded and may differ from the proportions in reality in some cases.

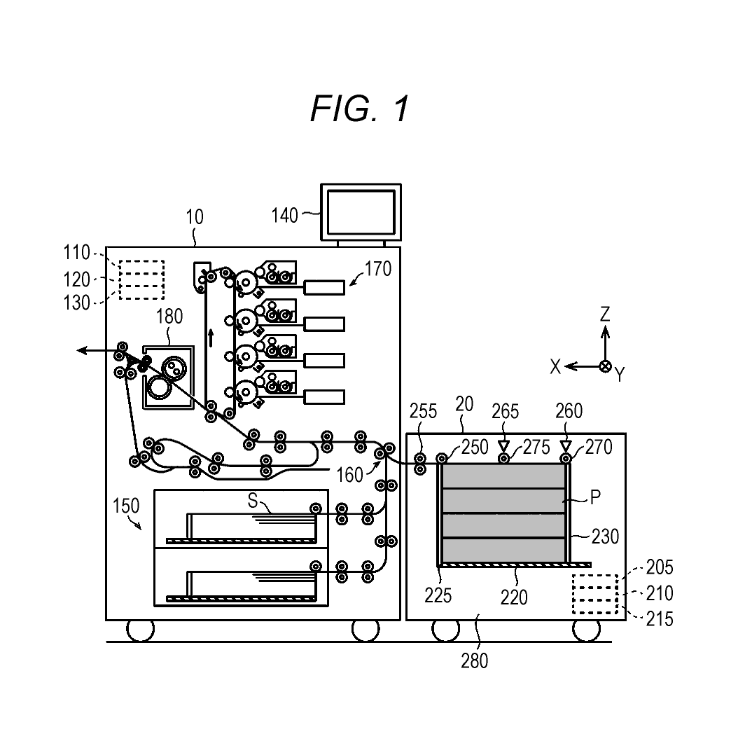

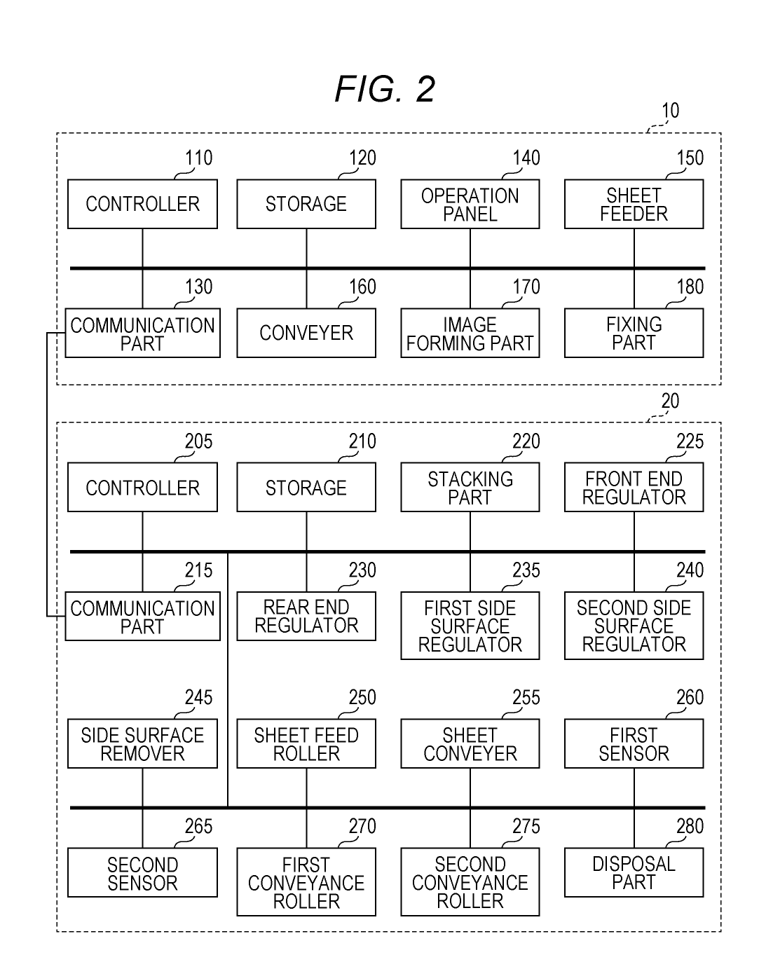

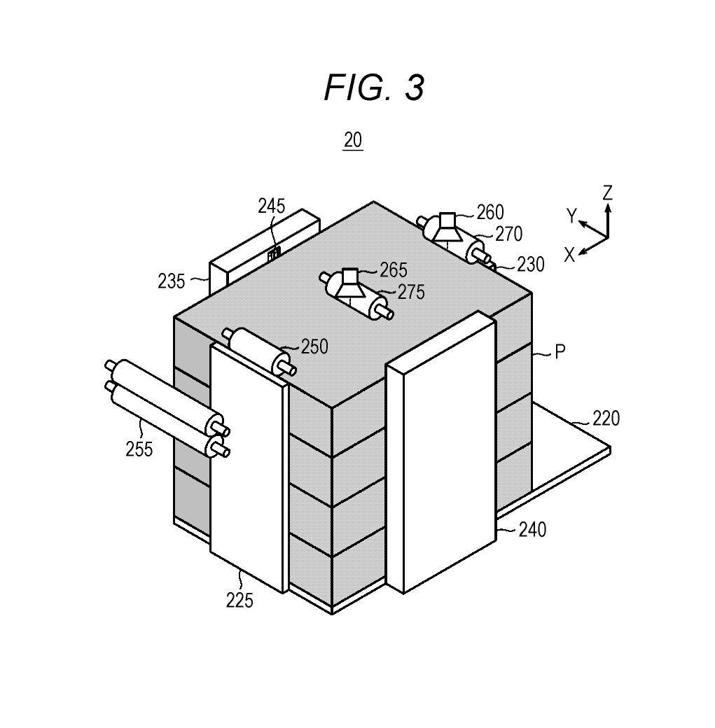

FIG. 1 is a diagram illustrating a schematic configuration of an image forming apparatus and a sheet feeding apparatus according to an embodiment of the present invention. FIG. 2 is a block diagram illustrating a schematic configuration of the image forming apparatus and the sheet feeding apparatus. FIG. 3 is a perspective view illustrating a schematic configuration of the sheet feeding apparatus.

(Image Forming Apparatus 10)

First, an image forming apparatus 10 will be described. As illustrated in FIGS. 1 and 2, the image forming apparatus 10 includes a controller 110, a storage 120, a communication part 130, an operation panel 140, a sheet feeder 150, a conveyer 160, an image forming part 170, and a fixing part 180. These are interconnected via a bus for exchanging signals. Moreover, as illustrated in FIG. 1, the image forming apparatus 10 is provided with a sheet feeding apparatus 20 externally installed to feed a printing sheet (hereinafter also simply referred to as a “sheet”) to the image forming apparatus 10.

The controller 110 is a central processing unit (CPU) and executes control of each of the above components and various types of computing processing in accordance with a program.

The storage 120 includes a read only memory (ROM) previously storing various programs and various data, a random access memory (RAM) temporarily storing programs and data as a work region, and a hard disk storing various programs and various data.

The communication part 130 is an interface for communicating with another device such as a user's personal computer (PC) and receives a print job and various instructions from the user's PC or the like.

The operation panel 140 includes a touch panel, a ten-key pad, a start button, and a stop button and is used for displaying various types of information and inputting various instructions.

The sheet feeder 150 includes: a plurality of stacking parts (sheet feeding trays) for stacking a bundle of sheets S as recording materials used for printing; and a sheet feed roller that separates the sheet S one by one and feeds the separated sheet to the conveyer 160,

The conveyer 160 includes a conveyance path, a plurality of conveyance roller pairs arranged along the conveyance path, and a drive motor (not illustrated) for driving the conveyance roller pair. The conveyer 160 conveys the sheet S fed from the sheet feeder 150 or the sheet feeding apparatus 20 to the image forming part 170, the fixing part 180, or the like, located on the downstream side of sheet conveyance.

The image forming part 170 forms an image based on the image data on the sheet S by using a known imaging process such as an electrophotographic process. The image forming part 170 transfers a toner image formed on a transfer belt by the image forming part onto the sheet S to form an image on the sheet S.

The fixing part 180 fixes an image formed on the sheet S by the image forming part 170. The fixing part 180 includes a pressure roller and a heating roller, and presses and heats the sheet S on which an image is formed, so as to fuse the image onto the sheet S. The sheet S on which the image is fixed by the fixing part 180 is discharged to the outside of the image forming apparatus 10 by the conveyer 160.

(Sheet Feeding Apparatus 20)

Next, the sheet feeding apparatus 20 will be described. As illustrated in FIGS. 1 to 3, the sheet feeding apparatus 20 includes a controller 205, a storage 210, a communication part 215, a stacking part 220, a front end regulator 225, a rear end regulator 230, a first side surface regulator 235, a second side surface regulator 240, a side surface remover 245, a sheet feed roller 250, a sheet conveyer 255, a first sensor 260, a second sensor 265, a first conveyance roller 270, a second conveyance roller 275, and a disposal part 280. Since the controller 205, the storage 210, and the communication part 215 of the sheet feeding apparatus 20 have functions similar to those of the above-described portions of the image forming apparatus 10, the description thereof will be omitted.

The stacking part 220 is a plate-like member, and a plurality of sheet packs P can be stacked and mounted on the stacking part 220. The sheet pack P is a bundle of stacked sheets S wrapped with a wrapping sheet W. The stacking part 220 is capable of ascending and descending by a lifting drive motor (not illustrated), and ascends and descends to set an upper surface of the stacked sheet pack P, or of the sheet S included in the sheet pack P to be located at a predetermined height. The amount of stacked sheet packs P or sheets S can be determined by the position (height) of the stacking part 220. Four side surfaces of the stacked sheet pack P (wall surfaces along the stacking direction of the sheet S among the wall surfaces of the sheet pack P) have regulations such that a front end being regulated by the front end regulator 225, a rear end regulated by the rear end regulator 230, and the remaining side surfaces regulated by the first side surface regulator 235 and the second side surface regulator 240. The front end regulator 225 is fixed to a casing of the sheet feeding apparatus 20 and the rear end regulator 230, the first side surface regulator 235, and the second side surface regulator 240 are movable in accordance with the size of the sheet pack P stacked on the stacking part 220. Note that the “front end” means an end on the sheet feeding side in the sheet feed direction (x direction in FIG. 3) of the sheet S, the “rear end” means the end on the opposite side to the sheet feeding side, and a “central part” means the vicinity of the center of the front end and the rear end.

The side surface remover 245 removes the wrapping sheet W (hereinafter referred to as a “side surface wrapping sheet WS”) on the side surface of the sheet pack P stacked on the stacking part 220. The side surface remover 245 includes a preparatory cutting blade and at least one pipe member, for example. The side surface remover 245 may be accommodated in a slit part provided in the first side surface regulator 235 or the like while the removal processing of the side surface wrapping sheet WS is not being executed, as illustrated in FIG. 3, for example. The configuration of the side surface remover 245 and the method of removing the side surface wrapping sheet WS will be described below.

The sheet feed roller 250 separates the sheets S contained in the sheet pack P stacked on the stacking part 220 one by one and feeds the separated sheet S to the sheet conveyer 255.

The sheet conveyer 255 has a configuration substantially similar to the configuration of the conveyer 160 of the image forming apparatus 10, and conveys the sheet S fed from the sheet feed roller 250 to the image forming apparatus 10 located on the downstream side of sheet conveyance.

The first sensor 260 and the second sensor 265 are optical sensors such as a charge coupled device (CCD) and a contact image sensor (CIS). The first sensor 260 and the second sensor 265 detect whether the uppermost sheet stacked on the stacking part 220 in a detection range is either the wrapping sheet W or the sheet S.

The first sensor 260 is arranged above the sheet pack P stacked on the stacking part 220 and on the rear end side of the sheet pack P. That is, the detection range of the first sensor 260 is in the rear end side of the sheet pack P stacked on the stacking part 220. The “rear end side” represents a rear half side of the sheet pack P stacked on the stacking part 220, preferably close to the rear end and corresponding to a range less than 10 mm from the rear end in the sheet feed direction of the sheet S.

The second sensor 265 is arranged above the sheet pack P stacked on the stacking part 220 and at a central part of the sheet pack P. That is, the detection range of the second sensor 265 is in the central part of the sheet pack P stacked on the stacking part 220. The “central part” is preferably a range less than 10 mm from the center in the sheet feed direction of the sheet S.

For example, the first sensor 260 and the second sensor 265 are movably provided on a ceiling part of the casing of the sheet feeding apparatus 20. For example, the first sensor 260 and the second sensor 265 detect that the sheet having a color other than white and having a pattern, or includes a sticking portion, as the wrapping sheet W. Moreover, the first sensor 260 and the second sensor 265 detect that the sheet being white and having no pattern, and not including a sticking portion, as the sheet S. The color or pattern information of the wrapping sheet W may be pre-registered and stored in the storage 210 or the like. The first sensor 260 and the second sensor 265 may constantly detect the uppermost sheet in the detection range during operation of the sheet feeding apparatus 20. Alternatively, the first sensor 260 and the second sensor 265 may detect selectively in a predetermined case that can be a case needing removal of the wrapping sheet W, such as during the feeding of the sheet S or after the sheet pack P is installed. Hereinafter, the first sensor 260 and the second sensor 265 will be collectively referred to simply as a “sensor”.

The first conveyance roller 270 and the second conveyance roller 275 are conveyance rollers that convey the remove the wrapping sheet W on the upper and lower surfaces of the sheet pack P (wall surface perpendicular to the stacking direction of the sheet S among the wall surface of the sheet pack P) stacked on the stacking part 220. Each of the first conveyance roller 270 and the second conveyance roller 275 includes a drive motor (not illustrated) and rotates at a predetermined speed.

The first conveyance roller 270 conveys the wrapping sheet W detected by the first sensor 260 to a path different from a path through which the sheet conveyer 255 conveys the sheet S. For example, the first conveyance roller 270 conveys the wrapping sheet W to a path in a direction opposite to the path through which the sheet S is conveyed from the stacking part 220. The first conveyance roller 270 is arranged on the rear end side of the sheet pack P, that is, in the vicinity of the first sensor 260.

The second conveyance roller 275 conveys the wrapping sheet W detected by the second sensor 265 to a path different from a path through which the sheet conveyer 255 conveys the sheet S. For example, the second conveyance roller 275 conveys the wrapping sheet W to a path in a direction opposite to the path through which the sheet S is conveyed from the stacking part 220. The second conveyance roller 275 is arranged on the central part of the sheet pack P, that is, in the vicinity of the second sensor 265.

The rotational direction and rotational speed of the first conveyance roller 270 and the second conveyance roller 275 are preferably substantially similar to each other. The first conveyance roller 270 and the second conveyance roller 275 are different in the rotational direction from the sheet feed roller 250. The positional relationship between the first sensor 260 and the first conveyance roller 270 and the positional relationship between the second sensor 265 and the second conveyance roller 275 are not limited to the examples illustrated in FIGS. 1 and 3. For example, the first sensor 260 and the first conveyance roller 270 may be arranged adjacent to each other in they direction illustrated in FIG. 3, and the second sensor 265 and the second conveyance roller 275 may be arranged adjacent to each other in the y direction. Hereinafter, the first conveyance roller 270 and the second conveyance roller 275 will be collectively referred to as a “conveyer”.

The disposal part 280 includes a disposal space for discarding the wrapping sheet W of the sheet pack P. The disposal part 280 accommodates the wrapping sheet W discarded by the side surface remover 245, the first conveyance roller 270, and the second conveyance roller 275. The disposal part 280 may be an entire bottom portion of the sheet feeding apparatus 20, for example. Alternatively, the disposal part 280 may be provided at an arbitrary position of the sheet feeding apparatus 20. The wrapping sheet W discarded in the disposal part 280 can be extracted by a user.

The image forming apparatus 10 and the sheet feeding apparatus 20 may include constituent elements other than the above-described constituent elements, or need not include a portion of the above constituent elements.

(Method of Removing Side Surface Wrapping Sheet WS)

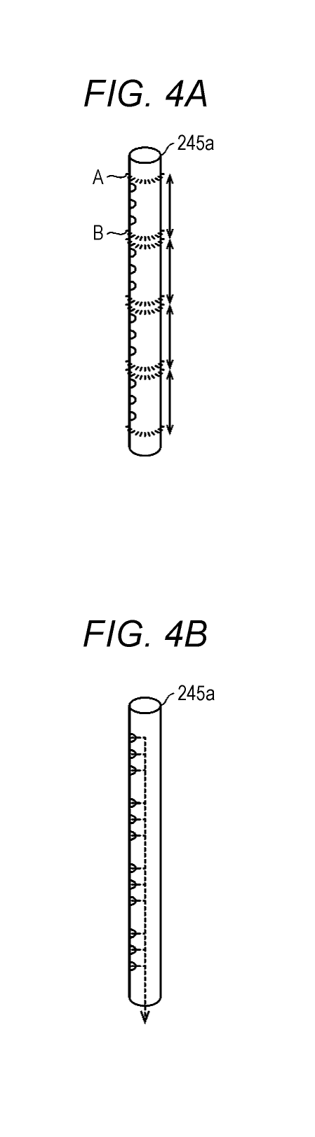

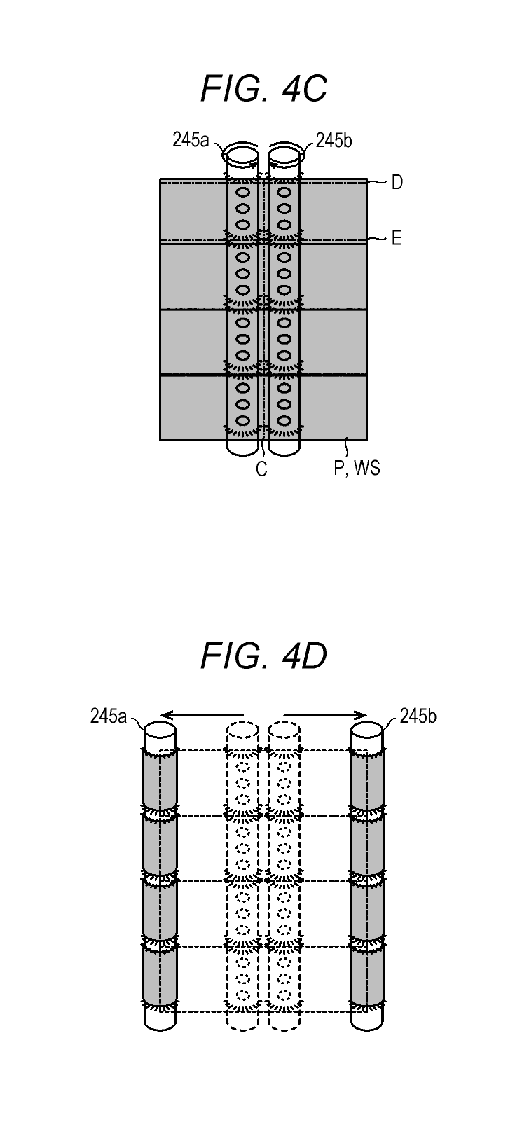

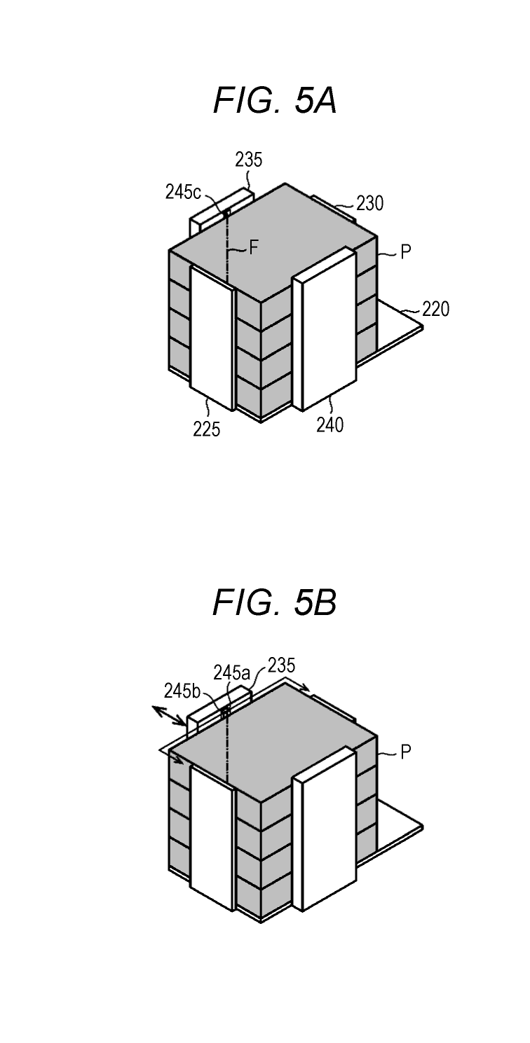

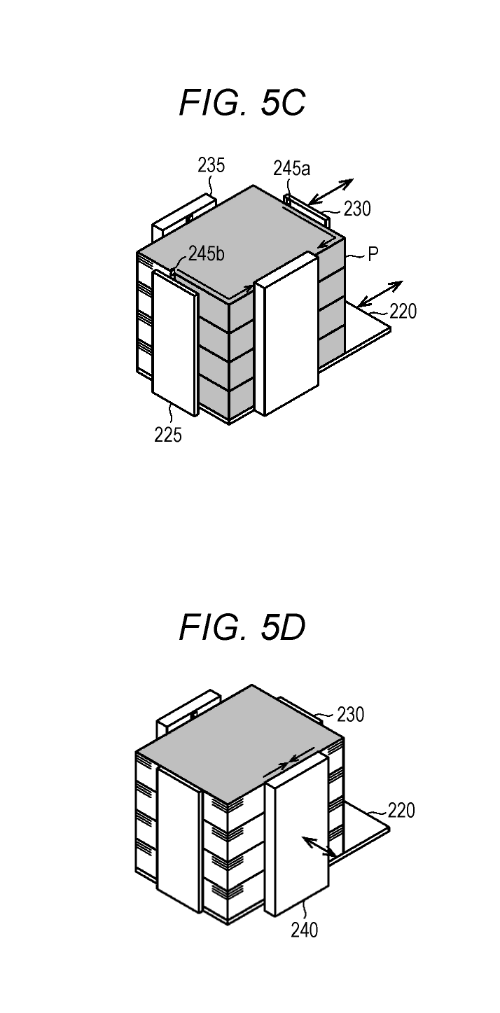

Next, with reference to FIGS. 4A to 4D and FIGS. 5A to 5D, a method of removing the side surface wrapping sheet WS of the sheet pack P will be described.

FIG. 4A is a diagram illustrating a pipe member provided in a side surface remover. A pipe member 245a is a cylindrical hollow member having on an outer peripheral surface a plurality of holes connecting the outer and inner sides of the pipe member 245a and having a plurality of cutting blades. The pipe member 245a has a plurality of cutting blades as a group of cutting blades arranged on the outer peripheral surface of the pipe member 245a at predetermined intervals. The interval between the cutting blade group A and the cutting blade group B illustrated in FIG. 4A corresponds to the height of the sheet pack P (dimension along the stacking direction of the sheet S among the sizes of the sheet pack P), and the interval is preferably equal to or a few mm smaller than the height of the sheet pack P. Moreover, as illustrated in FIG. 4A, the pipe member 245a may include the plurality of holes and cutting blades such that the arrangement of the holes and the cutting blades between the cutting blade group A and the cutting blade group B are repeated a plurality of times in a longitudinal direction of the pipe member 245a. Note that the number, arrangement and the unit of repetition of the holes and the cutting blades of the pipe member 245a are not limited to the example illustrated in FIG. 4A.

FIG. 4B is a diagram illustrating a state in which the pipe member 245a sucks air. The pipe member 245a can suck air from any one of the two ends in any manner. The pipe member 245a may include an air suction mechanism such as a suction fan at one end (for example, the bottom of the pipe member 245a) of the two ends. Suction of air from the end of the pipe member 245a sets the inside at a negative pressure and causes the air to be sucked also from the hole of the pipe member 245a. Therefore, in a case where a sheet exists outside the hole of the pipe member 245a, the pipe member 245a can suck and hold the sheet. To enhance the suction force of the pipe member 245a, the end of the pipe member 245a not having the air suction mechanism among the two ends may be closed.

FIGS. 4C and 4D are diagrams illustrating states in which the pipe members remove a side surface wrapping sheet of the sheet pack.

FIGS. 4C and 4D are perspective views of the pipe members 245a and 245b from the inside of the sheet pack P, in which the pipe members 245a and 245b are positioned on the back side of the sheet pack P. Moreover, each of the sheet packs P is assumed to have a cut beforehand at the position indicated by a one-dot chain line C illustrated in FIG. 4C by a preparatory cutting blade or the like to be described below.

In the state illustrated in FIG. 4C, the pipe member 245a and the pipe member 245b having a configuration similar to that of the pipe member 245a start suction of the side surface wrapping sheet WS of the sheet pack P in the vicinity of the one-dot chain line C on the side surface of the sheet pack P. That is, the pipe members 245a and 245b adjacent to each other suck a portion of the side surface wrapping sheet WS by the plurality of holes on the side surface of the sheet pack P and hold the sheet on the outer peripheral surface. Then, the pipe members 245a and 245b move in directions away from each other while rotating in the direction of the arrow illustrated in FIG. 4C. At this time, the pipe members 245a and 245b move while making cuts, by a plurality of cutting blades, at position of one-dot chain lines D and E of the side surface wrapping sheet WS illustrated in FIG. 4C along a direction (horizontal direction) perpendicular to the stacking direction. With this configuration, the pipe members 245a and 245b can wind up the side surface wrapping sheet WS as illustrated in FIG. 4D.

Next, a method of removing the wrapping sheet W on the four side surfaces of the sheet pack P using the pipe members 245a and 245b as described above will be described.

FIGS. 5A to 5D are diagrams for illustrating a method of removing the side surface wrapping sheet of a sheet pack.

FIG. 5A illustrates a state in which the sheet pack P is stacked in the stacking part 220. In this state, the preparatory cutting blade 245c accommodated in the slit part provided in the first side surface regulator 235 first makes a cut at a position of a one-dot chain line F of the side surface wrapping sheet WS of the plurality of sheet packs P along the stacking direction (vertical direction). An example of the preparatory cutting blade 245c is a utility knife, and a cutting depth is assumed to be adjusted so as to cut the side surface wrapping sheet WS alone. Moreover, for convenience of explanation, FIGS. 5A to 5D omits illustration of the configurations other than the stacking part 220, the front end regulator 225, the rear end regulator 230, the first side surface regulator 235, the second side surface regulator 240, and the side surface remover 245.

Subsequently, as illustrated in FIG. 5B, the pipe members 245a and 245b accommodated in the slit part provided in the first side surface regulator 235 start to wind up the side surface wrapping sheet WS of the plurality of sheet packs P. As described with reference to FIGS. 4C and 4D, the pipe members 245a and 245b suck and hold the side surface wrapping sheet WS by a plurality of holes, and move rotationally while making cuts on the side surface wrapping sheet WS by the plurality of cutting blades, so as to wind up the side surface wrapping sheet WS. In this, however, the pipe members 245a and 245b cannot start winding up the side surface wrapping sheet WS when there is no gap between the first side surface regulator 235 and the sheet pack P. Therefore, as illustrated in FIG. 5B, the first side surface regulator 235 retracts in a direction away from the sheet pack P while the pipe members 245a and 245b move in the direction of the arrow between the first side surface regulator 235 and the sheet pack P. Note that the retracted first side surface regulator 235 returns to its original position after the pipe members 245a and 245b move between the first side surface regulator 235 and the sheet pack P.

Subsequently, as illustrated in FIG. 5C, the pipe members 245a and 245b continue to wind up the side surface wrapping sheet WS. In this, however, the pipe members 245a and 245b cannot continue winding up the side surface wrapping sheet WS when there is no gap between the front end regulator 225 and the sheet pack P, and between the rear end regulator 230 and the sheet pack P. Therefore, as illustrated in FIG. 5C, the rear end regulator 230 retracts in a direction away from the sheet pack P while the pipe members 245a moves in the direction of the arrow between the rear end regulator 230 and the sheet pack P. Note that the retracted rear end regulator 230 returns to its original position after the pipe member 245a moves between the rear end regulator 230 and the sheet pack P.

Meanwhile, there is a case where the front end regulator 225 is fixed to the casing of the sheet feeding apparatus 20, and thus cannot retract in the direction away from the sheet pack P. Therefore, in order to form a gap between the front end regulator 225 and the sheet pack P, the stacking part 220 may move together with each of the plurality of stacked sheet packs P, instead of allowing the front end regulator 225 to retract. That is, as illustrated in FIG. 5C, the stacking part 220 may move in a direction opposite to the sheet feed direction of the sheet S while the pipe member 245b moves in the arrow direction between the front end regulator 225 and the sheet pack P. Note that after the pipe member 245b moves between the front end regulator 225 and the sheet pack P, the stacking part 220 that has moved returns to its original position.

Similarly, as illustrated in FIG. 5D, the second side surface regulator 240 retracts in a direction away from the sheet pack P while the pipe members 245a and 245b move between the second side surface regulator 240 and the sheet pack P. The pipe members 245a and 245b stop suction of air from one end (that is, suction of the wrapping sheet W via the hole) after completion of winding of the side surface wrapping sheet WS. This causes the pipe members 245a and 245b to release the side surface wrapping sheet WS that has been wound. In a case where the disposal part 280 is located below the winding completion position, the pipe members 245a and 245b release the side surface wrapping sheet WS in the winding completion position. Alternatively, the pipe members 245a and 245b may carry the side surface wrapping sheet WS to the disposal part 280 provided at a certain position of the sheet feeding apparatus 20, and then, may release the side surface wrapping sheet WS at the position of the disposal part 280. Note that the pipe members 245a and 245b may deliver air to one end by any method and may discharge the delivered air from the hole to release the wound side surface wrapping sheet WS.

After releasing the side surface wrapping sheet WS, the pipe members 245a and 245b may be accommodated in a slit part (not illustrated) provided in the second side surface regulator 240. The slit part provided in the second side surface regulator 240 may accommodate another preparatory cutting blade. In this case, each time the side surface wrapping sheet WS is removed, the pipe members 245a and 245b can alternately move between the first side surface regulator 235 and the second side surface regulator 240, so as to be alternately accommodated in the individual slit parts. Alternatively, the slit part may be provided in the first side surface regulator 235 alone. In this case, after releasing the side surface wrapping sheet WS, the pipe members 245a and 245b may return to the slit part provided in the first side surface regulator 235.

As described above, after the plurality of sheet packs P is stacked on the stacking part 220, the sheet feeding apparatus 20 according to the present embodiment removes the side surface wrapping sheet WS before feeding of the sheet S is started.

While the above is an exemplary case where the side surface remover 245 includes the two pipe members 245a and 245b, the present embodiment is not limited to this. It is allowable to have a configuration in which the side surface remover 245 includes a single pipe member and this single pipe member moves around the entire circumference of the wrapping sheet W to remove the side surface wrapping sheet WS. Alternatively, the side surface remover 245 may include four pipe members in order to remove the side surface wrapping sheet WS more quickly. In this case, two pipe members may be accommodated in each of the slit parts provided in the first side surface regulator 235 and the second side surface regulator 240.

In addition, while the above is the case where the side surface remover 245 removes the side surface wrapping sheet WS of the plurality of sheet packs P at one time, the present embodiment is not limited thereto. For example, the side surface remover 245 may include a short pipe member (that is, a short pipe member having a cutting blade group A to cutting blade group B illustrated in FIG. 4A) for selectively removing the side surface wrapping sheet WS of one sheet pack P. Then, the side surface remover 245 may sequentially remove the side surface wrapping sheet WS of the sheet pack P from the upper stack. It would be sufficient that, before completion of feeding of all the sheets S included in the upper sheet pack P among the plurality of sheet packs P stacked on the stacking part 220, the side surface remover 245 removes the side surface wrapping sheet WS of the sheet pack P at a lower position. The short pipe member may be movable in the up-down direction and may move downward at every completion of the winding of the side surface wrapping sheet WS of one sheet pack P and then may start winding of the side sheet wrapping sheet WS of the next sheet pack P. Alternatively, after completion of the winding up the side surface wrapping sheet WS of the uppermost stacked sheet pack P, the short pipe member may rest at a predetermined lower position. Subsequently, the short pipe member may start winding of the side surface wrapping sheet WS of the sheet pack P when the stacking part 220 rises with the feeding of the sheet S and the sheet pack P from which the side surface wrapping sheet WS has not been removed reaches the rest position.

For the sake of convenience of explanation, the pipe member 245a illustrated in FIG. 4A is formed such that the arrangement of the holes between the cutting blade group A and the cutting blade group B and arrangement of the cutting blade group is repeated four times in the longitudinal direction of the pipe member 245a. The present embodiment, however, is not limited to this. Moreover, the number of sheet packs P stacked on the stacking part 220 and the repeating unit of the holes and cutting blade group of the pipe member 245a need not match. For example, even in a case where one sheet pack P alone is stacked on the stacking part 220, the side surface remover 245 may use the pipe member 245a illustrated in FIG. 4A to remove the side surface wrapping sheet WS of the one sheet pack P. Each of the holes of the pipe member 245a may be configured to be openable and closable, and the hole not facing the sheet pack P may be closed in order to prevent the inflow of air from the hole not facing the sheet pack P and increase the suction force of the pipe member 245a against the side surface wrapping sheet WS.

(Method of Removing Upper Surface Wrapping Sheet WT and Lower Surface Wrapping Sheet WB)

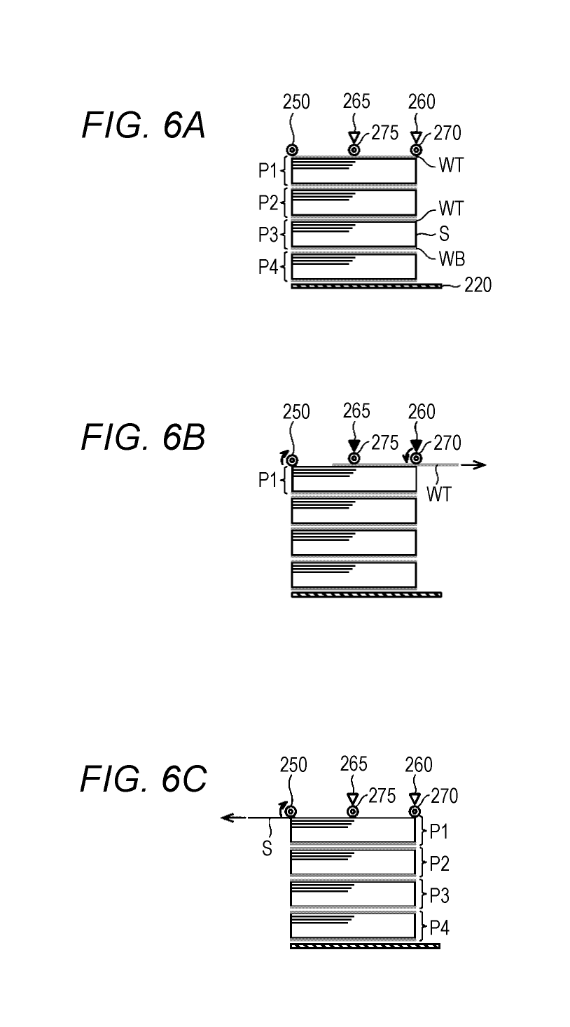

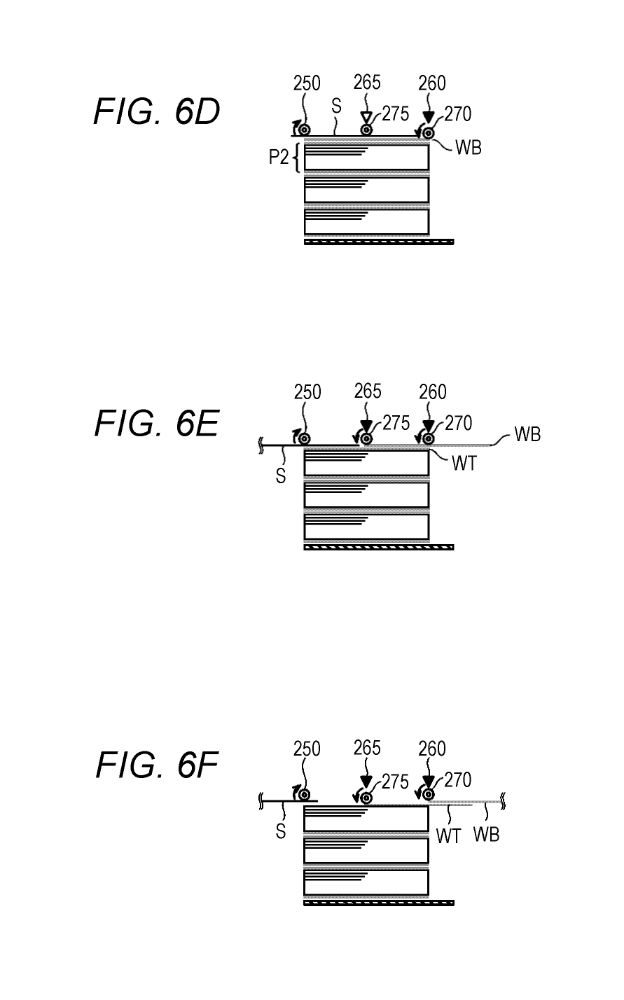

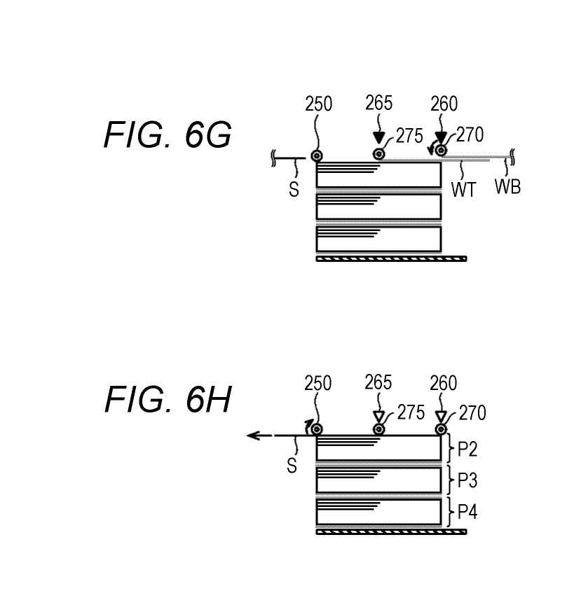

Subsequently, a method of removing the wrapping sheet W on the upper and lower surfaces of the sheet pack P will be described with reference to FIGS. 6A to 6H. In the following description, the wrapping sheet W on the upper surface of the sheet pack P will be referred to as an “upper surface wrapping sheet WT”, and the wrapping sheet W on the lower surface of the sheet pack P will be referred to as a “lower surface wrapping sheet WB”. Note that the upper surface and the lower surface of the sheet pack P do not represent the upper surface and the lower surface (for example, indicated by the presence or absence of the bonded portion) of the structure of the sheet pack P itself, but represent the upper surface and the lower surface of the sheet pack P in the state of being stacked on the stacking part 220.

FIGS. 6A to 6H are diagrams for illustrating a method of removing the upper and lower surface wrapping sheets of the sheet pack P. In these figures, the leftward direction is a conveyance direction of the sheet S, and the rightward direction opposite to this is the conveyance direction of the wrapping sheet W.

FIG. 6A illustrates a state after the side surface wrapping sheet WS of the sheet pack P stacked on the stacking part 220 is removed by the method of removing the side surface wrapping sheet WS as described above. Each of the sheet packs P1 to P4 includes the upper surface wrapping sheet WT, a bundle of sheets S, and the lower surface wrapping sheet WB in order from the top. Therefore, the upper surface wrapping sheet WT of another sheet pack P overlaps the lower surface wrapping sheet WB of each of the sheet packs P from below. In this state, the first sensor 260 and the second sensor 265 start detecting the uppermost sheet in a detection range. The first sensor 260 detects the upper surface wrapping sheet WT of the sheet pack P1 as the uppermost sheet.

For the sake of convenience of explanation, the first sensor 260 and the second sensor 265 are assumed to detect the sheet located immediately below. Moreover, for convenience of explanation, FIGS. 6A to 6H omit illustration of the front end regulator 225, the rear end regulator 230, the first side surface regulator 235, the second side surface regulator 240, the side surface remover 245, and the sheet conveyer 255, and illustrates a state where there are gaps between individual sheet packs and gaps between individual sheets.

When the first sensor 260 starts detecting the upper surface wrapping sheet WT of the sheet pack P1, the first conveyance roller 270 rotates in the direction of the arrow to start conveyance of the upper surface wrapping sheet WT of the sheet pack P1 in the direction opposite to the sheet feed direction of the sheet S, as illustrated in FIG. 6B. The first conveyance roller 270 continues conveying the upper surface wrapping sheet WT until the first sensor 260 finishes detecting the upper surface wrapping sheet WT (starts detecting the sheet S). The rotational direction of the first conveyance roller 270 is opposite to the rotational direction of the sheet feed roller 250. Hereinafter, the rotation of the sheet feed roller 250 is also referred to as “normal rotation”, and the rotation of the first conveyance roller 270 and the second conveyance roller 275 is also referred to as “reverse rotation”.

When the first conveyance roller 270 starts conveying the upper surface wrapping sheet WT of the sheet pack P1, the sheet feed roller 250 starts normal rotation in the direction of the arrow to enable feeding the sheet S. Note that the load of the first conveyance roller 270 is preferably lower than the load of the sheet feed roller 250 so as to enable the sheet feed roller 250 to feed the sheet S while the first conveyance roller 270 conveys the upper surface wrapping sheet WT.

In addition, the second conveyance roller 275 is set free to rotate. Alternatively, the second conveyance roller 275 may be set to rotate in the same direction at the same speed as the first conveyance roller 270 for a limited duration in which the second sensor 265 detects the upper surface wrapping sheet WT of the sheet pack P1. The load of the second conveyance roller 275 is preferably smaller than the load of the sheet feed roller 250.

When the first sensor 260 finishes detecting the upper surface wrapping sheet WT, the first conveyance roller 270 stops reverse rotation and is set free to rotate as illustrated in FIG. 6C. Meanwhile, the sheet feed roller 250 can continue feeding the sheet S.

Subsequently, when the sheet feed roller 250 starts feeding the last sheet S included in the sheet pack P1, the first sensor 260 starts detection of the lower surface wrapping sheet WB of the sheet pack P1 as illustrated in FIG. 6D. When the first sensor 260 starts detecting the lower surface wrapping sheet WB, the first conveyance roller 270 reversely rotates in the direction of the arrow and starts conveying the lower surface wrapping sheet WB in a direction opposite to the sheet feed direction of the sheet S. In the state illustrated in FIG. 6D, since the second sensor 265 continues detecting the sheet S, the second conveyance roller 275 remains free to rotate.

When the sheet feed roller 250 starts feeding the last sheet S, the second sensor 265 starts detection of the lower surface wrapping sheet WB of the sheet pack P1 or the upper surface wrapping sheet WT of the sheet pack P2 as illustrated in FIG. 6E. Hereinafter, the “lower surface wrapping sheet WB of the sheet pack P1” will be also referred to as “the preceding wrapping sheet” while “the upper surface wrapping sheet WT of the sheet pack P2” will be also referred to as the “succeeding wrapping sheet”. In starting detection of the wrapping sheet W by the second sensor 265, which of the preceding wrapping sheet and the succeeding wrapping sheet is to be first detected depends on the relationship of magnitudes of the rotational speeds of the sheet feed roller 250 and the first conveyance roller 270, or the like. When the second sensor 265 starts to detect the preceding wrapping sheet or the succeeding wrapping sheet, the second conveyance roller 275 reversely rotates in the direction of the arrow to start conveyance of the preceding wrapping sheet or the succeeding wrapping sheet in the direction opposite to the sheet feed direction of the sheet S, as illustrated in FIG. 6E. Even in a case where the conveyance of the second conveyance roller 275 is started from the preceding wrapping sheet, the second conveyance roller 275 conveys the succeeding wrapping sheet as illustrated in FIG. 6F after passing the rear end of the preceding wrapping sheet.

When conveyance of the preceding wrapping sheet and the succeeding wrapping sheet is continued, the first sensor 260 detects the rear end of the preceding wrapping sheet as illustrated in FIG. 6G. In a case where the first sensor 260 detects the rear end of the preceding wrapping sheet, the second conveyance roller 275 stops reverse rotation and is set free to rotate even in a case where the second sensor 265 continues detecting the succeeding wrapping sheet. For example, the first sensor 260 may detect a level difference between the preceding wrapping sheet and the succeeding wrapping sheet so as to detect passage of the rear end of the preceding wrapping sheet.

The reason why the second conveyance roller 275 is set free to rotate even when the second sensor 265 is continuously detecting the succeeding wrapping sheet is to reliably avoid a situation in which the sheet S is pulled by the second conveyance roller 275 and by the sheet feed roller 250 against each other. The bundle of sheets S is positioned under the succeeding wrapping sheet, and thus, in a case where the second conveyance roller 275 comes in contact with the sheet S in reverse rotation, the sheet S would be pulled by the second conveyance roller 275 and the sheet feed roller 250 in normal rotation against each other. In order to avoid this, the present embodiment has a configuration in which the second conveyance roller 275 is set free to rotate at a point when the first conveyance roller 270 is enabled to convey the succeeding wrapping sheet (that is, point when the first sensor 260 detects the rear end of the preceding wrapping sheet).

Note that the second conveyance roller 275 may be set free to rotate at a point when the second sensor 265 finishes detecting the succeeding wrapping sheet. In this case, however, the sheet S might be slightly pulled depending on the positional relationship between the second sensor 265 and the second conveyance roller 275 or depending on the time from the completion of detection of the succeeding wrapping sheet by the second sensor 265 until the stop of the second conveyance roller 275. Accordingly, this point is to be considered in a case where the second conveyance roller 275 is to be set free to rotate at a point when the second sensor 265 finishes detecting the succeeding wrapping sheet.

When the first conveyance roller 270 continues conveying the succeeding wrapping sheet, the first sensor 260 finishes the detection of the succeeding wrapping sheet as illustrated in FIG. 6H. When the first sensor 260 finishes detecting the succeeding wrapping sheet, the first conveyance roller 270 stops reverse rotation and is set free to rotate. Meanwhile, the sheet feed roller 250 can continue feeding the sheet S. That is, the state of FIG. 6H is a state in which the sheet pack P1 alone has been used from the state of FIG. 6C. Accordingly, it is sufficient that the sheet feeding apparatus 20 repeats the processing illustrated in FIGS. 6C to 6H at every feeding of all sheets S included in each of the sheet packs P.

In this manner, the sheet feeding apparatus 20 according to the present embodiment removes the wrapping sheet W on the upper and lower surfaces after the start of the feeding of the last sheet S included in the sheet pack P stacked at the uppermost position of the stacking part 220 and before feeding of first sheet S included in another sheet pack P located immediately below.

(Processing Procedure of Sheet Feeding Apparatus 20)

Next, a processing procedure of the sheet feeding apparatus 20 will be described.

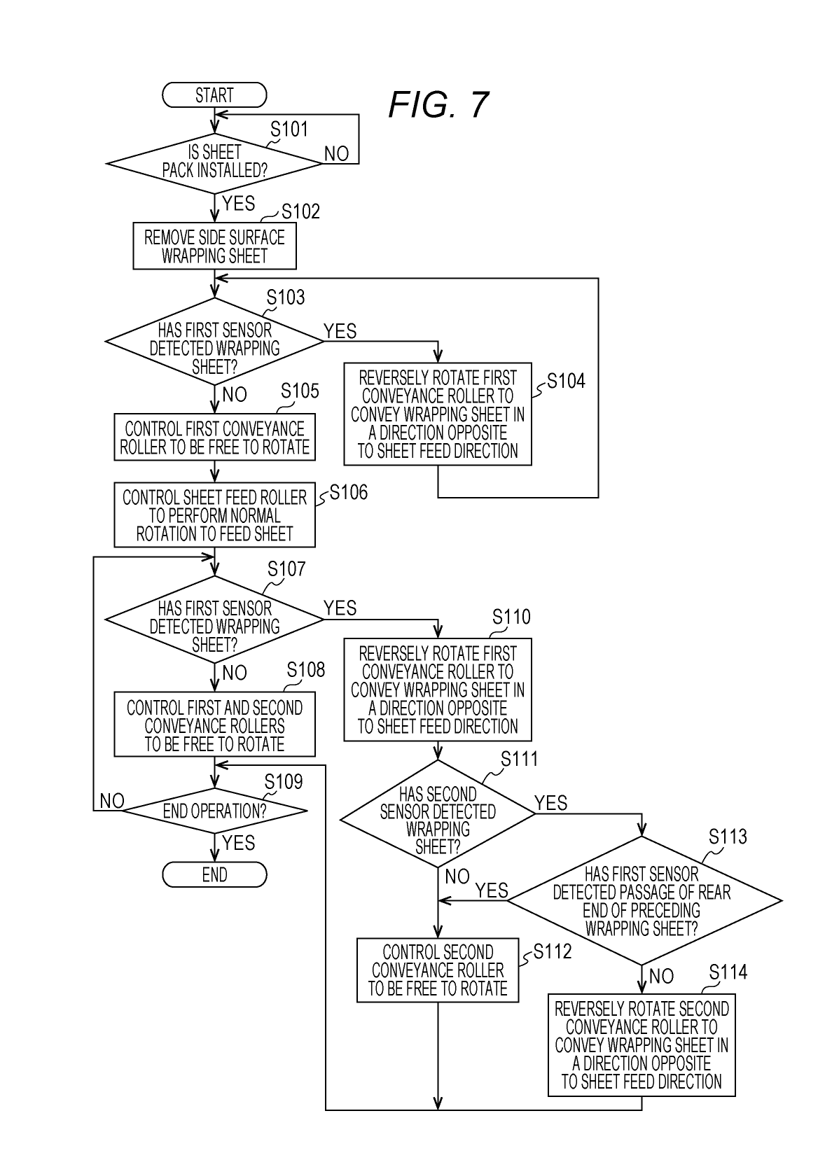

FIG. 7 is a flowchart illustrating a procedure of processing executed in the sheet feeding apparatus 20. The algorithm illustrated in the flowchart of FIG. 7 is stored as a program in the storage 210, and is executed by the controller 205. The controller 205 reads the program and executes processing so as to control the operation of individual components of the sheet feeding apparatus 20.

As illustrated in FIG. 7, the controller 205 first determines whether at least one sheet pack P has been newly installed on the stacking part 220 (step S101). This determination may be made in accordance with a change in the height of the sheet pack of the stacking part 220 or may be made in accordance with a user's instruction via the operation panel 140.

In a case where the sheet pack P has not been installed (step S101: NO), the controller 205 executes normal processing.

In a case where the sheet pack P has been installed (step S101: YES), the controller 205 controls the side surface remover 245 so as to remove the side surface wrapping sheet WS of at least one installed sheet pack P (step S102). That is, the controller 205 causes the side surface remover 245 to remove the side surface wrapping sheet WS by the method of removing the side surface wrapping sheet WS as described above. Moreover, as described above, the pipe members 245a and 245b of the side surface remover 245 cannot move without a gap between each of the front end regulator 225, the rear end regulator 230, the first side surface regulator 235, and the second side surface regulator 240, and the sheet pack P. Therefore, the controller 205 also controls the movement of the stacking part 220, and retraction of each of the rear end regulator 230, the first side surface regulator 235, and the second side surface regulator 240.

After removal of the side surface wrapping sheet WS, the controller 205 determines whether the first sensor 260 has detected the wrapping sheet W (step S103). That is, as illustrated in FIG. 6A, the controller 205 determines whether the first sensor 260 has detected the upper surface wrapping sheet WT of the uppermost stacked sheet pack P1.

In a case where the first sensor 260 has detected the wrapping sheet W (step S103: YES), the controller 205 reversely rotates the first conveyance roller 270 to cause the first conveyance roller 270 to convey the wrapping sheet W sheet S in the direction opposite to the sheet feed direction of the sheet S (step S104). That is, as illustrated in FIG. 6B, the controller 205 causes the first conveyance roller 270 to convey the upper surface wrapping sheet WT of the sheet pack P1. When the first conveyance roller 270 starts conveying the wrapping sheet W, the sheet feed roller 250 is enabled to feed the sheet S. The controller 205 repeats the processing of steps S103 and S104 until the first sensor 260 finishes detecting the upper surface wrapping sheet WT (starts detecting the sheet S).

In a case where the first sensor 260 has finished detecting the wrapping sheet W (step S103: NO), the controller 205 controls the first conveyance roller 270 to be free to rotate (step S105). Then, the controller 205 controls the sheet feed roller 250 to perform normal rotation to feed the sheet S (step S106). As described above, when the first conveyance roller 270 starts conveyance of the wrapping sheet W in step 104, the sheet feed roller 250 is enabled to feed the sheet S. Therefore, the controller 205 may cause the sheet feed roller 250 to start feeding the sheet S at the point of step S104. In the following, the controller 205 may cause the sheet feed roller 250 to feed the sheet S during execution of printing and to suspend feeding of the sheet S while printing is not being executed.

Subsequently, the controller 205 determines whether the first sensor 260 has detected the next wrapping sheet W (step S107).

In a case where the first sensor 260 has not detected the wrapping sheet W (step S107: NO), the controller 205 keeps the first conveyance roller 270 and the second conveyance roller 275 free to rotate (step S108), and proceeds to processing of S109. Then, the controller 205 confirms whether there was end operation of the sheet feeding apparatus 20 (step S109). The controller 205 repeats the processing of steps S107 to S109 until there is end operation of the sheet feeding apparatus 20 (step S109: YES) or the first sensor 260 starts detection of the wrapping sheet W (step S107: YES). The sheet feed roller 250 can continue feeding the sheet S while the processing of steps S107 to S109 is repeated, as illustrated in FIG. 6C.

In a case where the sheet feed roller 250 continues feeding the sheet S and the first sensor 260 starts detecting the wrapping sheet W (step S107: YES), the controller 205 proceeds to the processing of step S110. This case corresponds to a case where the sheet feed roller 250 started feeding the last sheet S included in the uppermost sheet pack P as illustrated in FIG. 6D. Then, the controller 205 reversely rotates the first conveyance roller 270 and causes the first conveyance roller 270 to convey the wrapping sheet W in the direction opposite to the sheet feed direction of the sheet S (step S110). That is, as illustrated in FIG. 6D, when the first sensor 260 starts detecting the lower surface wrapping sheet WB, the controller 205 causes the first conveyance roller 270 to convey the lower surface wrapping sheet WB.

Subsequently, the controller 205 determines whether the second sensor 265 has detected the wrapping sheet W (step S111).

In a case where the second sensor 265 has not detected the wrapping sheet W (step S111: NO), the controller 205 keeps the second conveyance roller 275 free to rotate (step S112), and proceeds to processing of S109. This case corresponds to a case where the first sensor 260 has detected the lower surface wrapping sheet WB and the second sensor 265 has not started detecting the lower surface wrapping sheet WB as illustrated in FIG. 6D. The controller 205 repeats the processing of steps S107, S109, and S110 to S112 until there is end operation of the sheet feeding apparatus 20 (step S109: YES) or until the second sensor 265 starts detection of the wrapping sheet W (step S111: YES).

In a case where the sheet feed roller 250 continues feeding the sheet S and the second sensor 265 starts detecting the wrapping sheet W (step S111: YES), the controller 205 proceeds to the processing of step S113. This case corresponds to a case where both the first sensor 260 and the second sensor 265 have detected the wrapping sheet W as illustrated in FIGS. 6E and 6F. Note that as described above whether the second sensor 265 starts detection of either the lower surface wrapping sheet WB of the uppermost stacked sheet pack P or the upper surface wrapping sheet WT of the next sheet pack P depends on the relationship between the rotational speeds of the sheet feed roller 250 and the first conveyance roller 270, or the like. Subsequently, the controller 205 determines whether the first sensor 260 has detected passage of the rear end of the wrapping sheet W (that is, the lower surface wrapping sheet WB illustrated in FIGS. 6E and 6F) for which the first conveyance roller 270 has previously started conveying (step S113).

In a case where the first sensor 260 has not detected passage of the rear end (step S113: NO), the controller 205 proceeds to the processing of step S114. Then, the controller 205 reversely rotates the second conveyance roller 275, and causes the second conveyance roller 275 to convey the wrapping sheet W in the direction opposite to the sheet feed direction of the sheet S (step S114). That is, as illustrated in FIGS. 6E and 6F, the controller 205 causes both the first conveyance roller 270 and the second conveyance roller 275 to convey the wrapping sheet W.

In a case where the first conveyance roller 270 continues conveyance of the wrapping sheet W and the first sensor 260 has detected passage of the rear end (step S113: YES), the controller 205 controls the second conveyance roller 275 to be free to rotate (step S112). That is, as illustrated in FIG. 6G, the controller 205 causes the first conveyance roller 270 alone to convey the wrapping sheet W.

In a case where the first conveyance roller 270 continues conveyance of the wrapping sheet W and the first sensor 260 finishes detecting the wrapping sheet W (step S107: NO), the controller 205 proceeds to the processing of step S108. Then, the controller 205 controls the first conveyance roller 270 to be free to rotate (step S108) in addition to the second conveyance roller 275. The controller 205 repeats the processing of steps S107 to S109 until there is end operation of the sheet feeding apparatus 20 (step S109: YES) or the first sensor 260 starts next detection of the wrapping sheet W (step S107: YES).

In a case where there is end operation of the sheet feeding apparatus 20 (step S109: YES), the controller 205 finishes the processing. Moreover, in a case where at least one sheet pack P is newly installed on the stacking part 220, the controller 205 may temporarily finish the processing and may execute the processing from the processing of step S101 again.

As described above, the controller 205 controls the first conveyance roller 270 and the second conveyance roller 275 so as to remove the wrapping sheet W on the upper and lower surfaces of the sheet pack P on the basis of detection status of each of the first sensor 260 and the second sensor 265.

As described above, the sheet feeding apparatus 20 causes the side surface remover 245 to remove the side surface wrapping sheet WS of the sheet pack P and detects the wrapping sheet W on the upper and lower surfaces of the sheet pack P by the sensor. In a case where the wrapping sheet W has been detected by the sensor, the conveyer conveys the wrapping sheet W detected on a path different from the conveyance path for the sheet S. As a result, the sheet feeding apparatus 20 can extract the upper and lower surface wrapping sheets W into different paths without interfering with the sheet feeding while feeding the sheet S. This omits necessity for the sheet feeding apparatus 20 to open the sheet pack P during printing, making it possible to enhance the efficiency in the processing of removing the wrapping sheet W of the sheet pack P.

Moreover, the sheet feeding apparatus 20 collectively removes the side surface wrapping sheets WS of the plurality of sheet packs P before the start of feeding of the sheet S. Therefore, the side surface remover 245 can enhance the efficiency in the processing of removing the side surface wrapping sheet WS. Moreover, the sheet feeding apparatus 20 removes the side surface wrapping sheet WS beforehand, enabling a remaining portion of the wrapping sheet W to be into a state of flat sheet conveyable by the conveyer.

Moreover, before completion of feeding of all the sheets S included in the upper sheet pack P, the sheet feeding apparatus 20 removes the side surface wrapping sheet WS of the sheet pack P at a lower position. It would be sufficient that the sheet feeding apparatus 20 removes the side surface wrapping sheet WS of the upper sheet pack P to start sheet feeding and then removes the side sheet wrapping sheet WS of the lower sheet pack P during execution of printing. Therefore, the sheet feeding apparatus 20 would be able to implement the present embodiment even without the side surface remover 245 corresponding to the height of the maximum number of sheet packs P that can be stacked in the stacking part 220.

Moreover, the side surface remover 245 of the sheet feeding apparatus 20 includes the cylindrical pipe member 245a having a plurality of holes and a plurality of cutting blades on its outer peripheral surface. The pipe member 245a sucks and holds the side surface wrapping sheet WS by the plurality of holes, and move rotationally while making cuts on the side surface wrapping sheet WS by the plurality of cutting blades, so as to wind up the side surface wrapping sheet WS of the sheet pack P. Accordingly, the sheet feeding apparatus 20 can remove the side surface wrapping sheet WS of the plurality of sheet packs P even in a state where the plurality of sheet packs P is stacked.

In addition, the sheet feeding apparatus 20 conveys the detected wrapping sheet W to a path in a direction opposite to the path through which the sheet S is conveyed from the stacking part 220. This enables the sheet feeding apparatus 20 to extract the upper and lower surface wrapping sheets W into different paths without interfering with the sheet feeding while feeding the sheet S.

Moreover, the detection range of the first sensor 260 in the sheet feeding apparatus 20 is in the rear end side of the sheet pack P stacked on the stacking part 220 in the sheet feed direction of the sheet S. Therefore, the sheet feeding apparatus 20 can immediately detect that the feeding of the last sheet S included in each sheet pack P is started.

Moreover, the first conveyance roller 270 is arranged on the rear end side of the sheet pack P in the sheet feeding apparatus 20, and conveys the wrapping sheet W detected by the first sensor 260. Therefore, the sheet feeding apparatus 20 can start the conveyance of the wrapping sheet W immediately after the start of feeding of the last sheet S included in each of the sheet packs P.

Moreover, in a case where the first sensor 260 has not detected the wrapping sheet W in the sheet feeding apparatus 20, the first conveyance roller 270 is controlled to be free to rotate. This makes it possible for the sheet feeding apparatus 20 to avoid hindering feeding of the sheet S even in a state where the first conveyance roller 270 is in contact with the sheet S.

Moreover, the first conveyance roller 270 starts conveying the wrapping sheet W in the sheet feeding apparatus 20 immediately after the first sensor 260 detects the wrapping sheet W. Therefore, the sheet feeding apparatus 20 can quickly start conveying the wrapping sheet W.

Moreover, the detection range of the second sensor 265 in the sheet feeding apparatus 20 is in a central part of the sheet pack P stacked on the stacking part 220 in the sheet feed direction of the sheet S. The sheet feeding apparatus 20 includes the second sensor 265 having a detection range different from the range of the first sensor 260, and thus can efficiently remove the two overlapping wrapping sheets W.

Moreover, the second conveyance roller 275 is arranged on the central part of the sheet pack Pin the sheet feeding apparatus 20, and conveys the wrapping sheet W detected by the second sensor 265. In a case where the second conveyance roller 275 is located near the first conveyance roller 270, it would be difficult to start conveying the succeeding wrapping sheet overlapping under the preceding wrapping sheet. Moreover, in a case where the second conveyance roller 275 is located near the sheet feed roller 250, it would be difficult to start conveying the succeeding wrapping sheet overlapping under the last sheet S. Therefore, the sheet feeding apparatus 20 includes the second conveyance roller 275 arranged in the central part of the sheet pack P, making it possible to more efficiently remove the two overlapping wrapping sheets W.

Moreover, in a case where the second sensor 265 has not detected the wrapping sheet W in the sheet feeding apparatus 20, the second conveyance roller 275 is controlled to be free to rotate. This makes it possible for the sheet feeding apparatus 20 to avoid hindering feeding of the sheet S even in a state where the second conveyance roller 275 is in contact with the sheet S.

Moreover, the sheet feeding apparatus 20 is configured in consideration of a case where the first conveyance roller 270 conveys the first wrapping sheet while the second conveyance roller 275 conveys the second wrapping sheet overlapping below the first wrapping sheet. In this case, the second conveyance roller 275 is controlled to be free to rotate in a case where the first sensor 260 has detected passage of the rear end of the first wrapping sheet. This configuration enables the sheet feeding apparatus 20 to reliably avoid a situation in which the sheet S is pulled by the second conveyance roller 275 and by the sheet feed roller 250 against each other.

Moreover, the sheet feeding apparatus 20 conveys the wrapping sheet W after the start of the feeding of the last sheet S included in the sheet pack P stacked at the uppermost position of the stacking part 220 and before feeding of sheet S included in another sheet pack P located immediately below. The sheet feeding apparatus 20 can start conveying the wrapping sheet W without waiting for the completion of the feeding of the last sheet S, and thus can enhance the efficiency of the processing of removing the wrapper sheet W.

The above-described embodiment is an example of the procedure of the processing of the sheet feeding apparatus 20. The present embodiment, however, is not limited to this. Various modifications, enhancements or the like as described below are possible.

The above-described embodiment is an exemplary case where the preparatory cutting blade 245c makes cuts on the side surface wrapping sheet WS before the pipe members 245a and 245b of the side surface remover 245 start winding up the side surface wrapping sheet WS. The present embodiment, however, is not limited to this. The side surface remover 245 need not include the preparatory cutting blade 245c in a case where the pipe members 245a and 245b can hold the side surface wrapping sheet WS and can rotate in mutually different directions to tear the side surface wrapping sheet WS even without cuts made by the preparatory cutting blade 245c.

In addition, the description includes a case where the first conveyance roller 270 and the second conveyance roller 275 convey the upper and lower surface wrapping sheets W to a path in a direction opposite to the conveyance path of the sheet S. The present embodiment, however, is not limited to this. The first conveyance roller 270 and the second conveyance roller 275 may convey the upper and lower surface wrapping sheets W to a path in a direction intersecting the conveyance path of the sheet S, for example. In this case, the first sensor 260 and the first conveyance roller 270 may be arranged, for example, on the end side in a width direction of the sheet pack P.

Alternatively, the sheet feeding apparatus 20 may convey the upper and lower surface wrapping sheets W in the same path as the conveyance path of the sheet S up to the middle of the path, and may convey the wrapping sheets W by a path branched from the middle, that is different from the conveyance path of the sheet S and may discard the wrapping sheets W to the disposal part 280 or the like located beyond the path. This makes it possible to apply the present embodiment even in a case where the sheet feeding apparatus 20 has a difficulty conveying the upper and lower surface wrapping sheets W to the backside of the stacking part 220 or the like.

Moreover, the sheet feeding apparatus 20 removes the wrapping sheet W of the sheet pack P according to the description. The present embodiment, however, is not limited to this. The material for wrapping the bundle of sheets S may be a material such as a film other than paper, for example, and it is possible to apply the present embodiment with the sheet feeding apparatus 20 using a sheet pack P in which the bundle of sheets S is wrapped with a material other than paper.

Moreover, the sheet feeding apparatus 20 according to the above description includes the first sensor 260 and the first conveyance roller 270, together with the second sensor 265 and the second conveyance roller 275. The present embodiment, however, is not limited to this. The sheet feeding apparatus 20 can omit the second sensor 265 and the second conveyance roller 275. In this case, the rotational speed of the first conveyance roller 270 may be set to twice that of the sheet feed roller 250 so as to enable the first conveyance roller 270 to more efficiently remove the wrapping sheet W even without the second conveyance roller 275.

Hereinafter, modifications of the present embodiment will be described with reference to the drawings.

### Modification

The sheet feeding apparatus 20 according to the above embodiment includes the first sensor 260 and the second sensor 265 on a ceiling part of the casing of the sheet feeding apparatus 20. The sheet feeding apparatus 20 according to a modification includes the first sensor 260 and the second sensor 265 by another method.

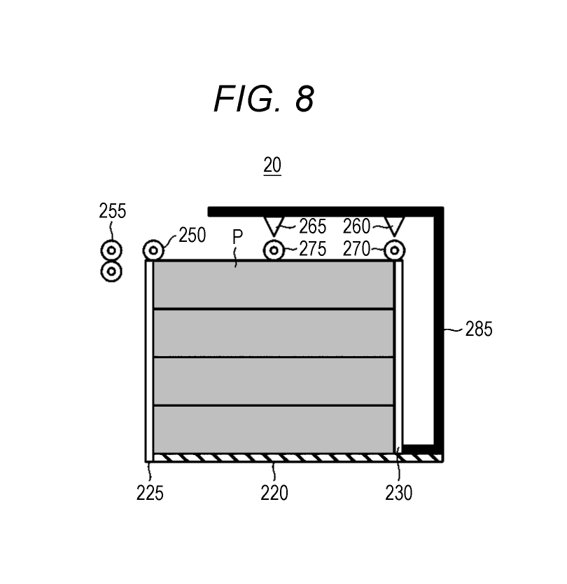

FIG. 8 is a diagram for illustrating the first sensor 260 and the second sensor 265 according to the modification.

As illustrated in FIG. 8, the first sensor 260 and the second sensor 265 of the modification are provided on a sensor mounting frame 285 connected to the rear end regulator 230. As described above, the rear end regulator 230 regulates the position of the rear end among the four side surfaces of the stacked sheet pack P, and can be moved in accordance with the size of the sheet pack P stacked on the stacking part 220. Therefore, the first sensor 260 and the second sensor 265 according to the modification move in conjunction with the rear end regulator 230 that moves in accordance with the size of the sheet pack P. The first sensor 260 may be configured to move by the same amount as the movement amount of the rear end regulator 230 in a case where the rear end regulator 230 moves. Moreover, the second sensor 265 may be configured to move by an amount that is half of the movement amount of the first sensor 260 by a mechanical mechanism including a wire and a moving pulley in a case where the rear end regulator 230 moves. Note that the first conveyance roller 270 and the second conveyance roller 275 may also be configured to move in conjunction with the rear end regulator 230.

As described above, the sheet feeding apparatus 20 according to the modification is configured to allow the sensor to move in conjunction with the rear end regulator 230. With this configuration, even when the size of the sheet pack P is changed, the first sensor 260 according to the modification can constantly detect the rear end side of the sheet pack P stacked on the stacking part 220. In addition, the second sensor 265 according to the modification moves by an amount that is half of the movement amount of the first sensor 260, and thus can constantly detect the central part of the sheet pack P stacked on the stacking part 220. Therefore, the sheet feeding apparatus 20 can constantly detect the rear end side and the central part of the sheet pack P even when the size of the sheet pack P is changed, enabling appropriate removal of the wrapping sheet W of the sheet pack P.

The above-described embodiment is a case where the sheet feeding apparatus 20 is one apparatus. The present embodiment, however, is not limited to this. For example, the sheet feeding apparatus 20 may have a configuration including an information processing apparatus to execute various types of determination processing and an apparatus to perform feeding of the sheet S, separate from each other. In this case, the information processing apparatus and the apparatus to execute feeding of the sheet S are connected with each other via a bus.

Moreover, the above-described embodiment has a configuration in which the image forming apparatus 10 and the sheet feeding apparatus 20 are separate apparatuses. The present embodiment, however, is not limited to this. Each of the apparatuses may be configured as a combined unit, and each of the apparatus may be included in another unit.

In addition, each of processing units in the above-described flowchart is obtained by dividing processing procedures in accordance with main processing tasks in order to facilitate understanding of the sheet feeding apparatus 20. The present embodiment is not limited by step classification methods or the names of the steps. Moreover, the processing executed by the sheet feeding apparatus 20 may be further divided into more substeps. Alternatively, one step may perform more processing tasks.

Techniques and methods to be used for executing various processing tasks in the sheet feeding apparatus 20 according to the above-described embodiments can be implemented by any of a dedicated hardware circuit and a computer programmed by a program. The above-described program may be provided in a computer-readable recording medium including a USB memory, a flexible disk, and a compact disc read only memory (CD-ROM), or may be provided online via a network such as the Internet. In this case, the program recorded in the computer-readable recording medium is generally transferred to a storage such as a hard disk and is stored in it. Alternatively, the above-described program may be provided as a separate piece of application software, or may be incorporated into software of the corresponding sheet feeding apparatus 20 as a function of the same apparatus.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sheet feeding apparatus comprising:
a stacking part capable of stacking a plurality of sheet packs including a bundle of stacked printing sheets being wrapped with a wrapping sheet;
a side surface remover that removes the wrapping sheet on a side surface being a wall surface along a stacking direction of the printing sheets among the wall surfaces of the sheet pack for each of the plurality of sheet packs stacked on the stacking part,
a sensor that detects whether an uppermost sheet stacked on the stacking part in a detection range is the wrapping sheet; and
a conveyer that conveys the detected wrapping sheet to a path different from a path through which the printing sheet is conveyed in a case where the wrapping sheet has been detected by the sensor.

2. The sheet feeding apparatus according to claim 1,
wherein the side surface remover removes the wrapping sheet on the side surface of the plurality of sheet packs after the plurality of sheet packs is stacked on the stacking part and before the feeding of the printing sheets is started.

3. The sheet feeding apparatus according to claim 1,
wherein before the completion of feeding of all of the printing sheets included in the upper sheet pack among the plurality of sheet packs stacked on the stacking part, the side surface remover removes the wrapping sheet on the side surface of the sheet pack at a lower position.

4. The sheet feeding apparatus according to claim 1,
wherein the side surface remover includes a cylindrical pipe member having a plurality of holes and a plurality of cutting blades on an outer peripheral surface of the remover,
the pipe member holds the wrapping sheet on the outer peripheral surface by suction with the plurality of holes on the side surface of the sheet pack and rotationally moves while making cuts in the wrapping sheet with the plurality of cutting blades so as to wind up the wrapping sheet on the side surface of the sheet pack.

5. The sheet feeding apparatus according to claim 1,
wherein the conveyer conveys the detected wrapping sheet to a path in a direction opposite to a path through which the printing sheet is conveyed from the stacking part.

6. The sheet feeding apparatus according to claim 5,
wherein the sensor includes a first sensor, and
a detection range of the first sensor is a rear end side of the sheet pack stacked on the stacking part in a sheet feed direction of the printing sheet.

7. The sheet feeding apparatus according to claim 6,
wherein the conveyer includes a first conveyance roller, and
the first conveyance roller is arranged on the rear end side of the sheet pack, and conveys the wrapping sheet detected by the first sensor to a path in a direction opposite to a path in which the printing sheet is conveyed.

8. The sheet feeding apparatus according to claim 7,
wherein the first conveyance roller is controlled to be free to rotate in a case where the wrapping sheet has not been detected by the first sensor.

9. The sheet feeding apparatus according to claim 7,
wherein the first conveyance roller starts conveying the wrapping sheet immediately after the wrapping sheet is detected by the first sensor.

10. The sheet feeding apparatus according to claim 7,
wherein the sensor further includes a second sensor, and
the detection range of the second sensor is a central part of the sheet pack stacked on the stacking part in the sheet feed direction of the printing sheet.

11. The sheet feeding apparatus according to claim 10,
wherein the conveyer further includes a second conveyance roller, and
the second conveyance roller is arranged on the central part of the sheet pack, and conveys the wrapping sheet detected by the second sensor to a path in a direction opposite to a path in which the printing sheet is conveyed.

12. The sheet feeding apparatus according to claim 11,
wherein the second conveyance roller is controlled to be free to rotate in a case where the wrapping sheet has not been detected by the second sensor.

13. The sheet feeding apparatus according to claim 11,
wherein the second conveyance roller is controlled to be free to rotate
in a case where the first conveyance roller is conveying the first wrapping sheet and the second conveyance roller is conveying the second wrapping sheet overlapping with the first wrapping sheet from below, and
in a case where the first sensor has detected passage of the rear end of the first wrapping sheet.

14. The sheet feeding apparatus according to claim 1,
wherein the conveyer conveys the wrapping sheet after the start of feeding of the last printing sheet included in the sheet pack stacked at the uppermost position of the stacking part and before the start of feeding of a printing sheet included in another sheet pack located immediately below the sheet pack.

15. The sheet feeding apparatus according to claim 1, further comprising
a rear end regulator that regulates a position of the side surface facing the side surface of the sheet feeding side among the side surfaces of the sheet pack stacked in the stacking part and that is movable in accordance with the size of the sheet pack,
wherein the sensor moves in conjunction with the rear end regulator.
